(19) United States
(12) Patent Application Publication
(10) Pub. No.: US 2025/0229507 A1
(43) Pub. Date: Jul. 17, 2025

(54) MULTILAYER ARTICLE COMPRISING METAL, THERMALLY CONDUCTIVE HYBRID, AND THERMALLY CONDUCTIVE CONTINUOUS FIBER COMPOSITE

(71) Applicant: Avient Corporation, Avon Lake, OH (US)

(72) Inventors: Yves CORDEAU, Birmingham, AL (US); Paul PUCKETT, Lake Jackson, TX (US); Dwight MOATS, Remlap, AL (US); Michael MOSLEY, Mobile, AL (US)

(73) Assignee: Avient Corporation, Avon Lake, OH (US)

(21) Appl. No.: 18/703,255

(22) PCT Filed: Oct. 21, 2022
(86) PCT No.: PCT/US2022/047378

§ 371 Date: Apr. 19, 2024

Related U.S. Application Data
(60) Provisional application No. 63/270,909, filed on Oct. 22, 2021.

(51) Int. Cl. B32B 15/08; B32B 1/08; B32B 27/08; B32B 27/12; B32B 27/20; B32B 27/38

(52) U.S. Cl. CPC B32B 15/08; B32B 1/08; B32B 27/08; B32B 27/12; B32B 27/20; B32B 27/38; B32B 2250/03; B32B 2260/021; B32B 2260/046; B32B 2262/106; B32B 2264/101; B32B 2264/107; B32B 2264/2032; B32B 2307/302; B32B 2597/00

(57) ABSTRACT

Embodiments of the present disclosure are directed to multilayer articles including a metal layer, a thermally conductive hybrid layer overlaying the metal layer, and a thermally conductive continuous fiber composite layer overlaying the thermally conductive hybrid layer. The thermally conductive hybrid layer includes a polymer matrix with glass or ceramic and a first thermally conductive material disposed therein.

### CLAIM OF PRIORITY

This application claims the benefit of U.S. Provisional Patent Application Ser. No. 63/270,909 bearing Attorney Docket Number 1202108 and filed on Oct. 22, 2021, which is hereby incorporated by reference in its entirety.

### TECHNICAL FIELD

Embodiments of the present disclosure are generally related to multilayer articles, and are specifically related to multilayer articles of metal, thermally conductive hybrid, and thermally conductive continuous fiber composite having reduced weight and improved heat transfer.

### BACKGROUND

Metal articles are heavy and may have desirable mechanical properties to withstand demanding environments. For example, gun barrels made of steel or titanium have the strength and stiffness to withstand the pressure created when a bullet is fired and maintain uniform bullet trajectories (i.e., grouping). Conventionally, in an attempt to reduce weight while maintaining these mechanical properties, the amount of metal may be reduced and replaced with a carbon fiber-reinforced thermoset resin. However, carbon fiber-reinforced thermoset resin may be a poor heat conductor, depending on the orientation of the carbon fiber. Thus, the heat retention in the gun barrel may be increased as compared to an all metal gun barrel, leading to reduced accuracy and wearing down of the gun barrel.

Accordingly, a continual need exists for improved metal articles that have reduced weight and improved heat transfer for the aforementioned applications.

### SUMMARY

Embodiments of the present disclosure are directed to articles comprising multilayer articles comprising a metal layer, a thermally conductive hybrid layer overlaying the metal layer, and a thermally conductive continuous fiber composite layer overlaying the thermally conductive hybrid layer, which have a reduced weight and improved heat transfer.

According to one embodiment, a multilayer article is provided. The multilayer article comprises a metal layer, a thermally conductive hybrid layer overlaying the metal layer, and a thermally conductive continuous fiber composite layer overlaying the thermally conductive hybrid layer. The thermally conductive hybrid layer comprises a polymer matrix with glass or ceramic and a first thermally conductive material disposed therein.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DRAWINGS

FIG. 1 is a schematic cross sectional view of a multilayer article according to one or more embodiments described herein;

FIG. 2 is a schematic cross sectional view of a gun barrel including the multilayer article according to one or more embodiments described herein;

FIG. 3 is an enlarged schematic cross sectional view of the gun barrel of FIG. 2;

FIG. 4 is another enlarged schematic cross sectional view of the gun barrel of FIG. 2;

FIG. 5 shows a graph of results from comparative bore temperature testing of barrels produced by one or more embodiments vs. steel barrel;

FIG. 6 shows a plot of results from comparative steel surface temperature testing of a barrel produced by one or more embodiments vs. a commercially available barrel;

FIG. 7 show a plot of results from comparative steel surface temperature testing of barrel produced in one or more embodiments to a commercially available barrel to determine rates of temperature increase; and

FIG. 8 shows a plot of results from a multi-layer interface temperature testing of barrel produced in one or more embodiments.

### DETAILED DESCRIPTION

Reference will now be made in detail to various embodiments of multilayer articles, specifically multilayer articles comprising a metal layer, a thermally conductive hybrid layer overlaying the metal layer, and a thermally conductive continuous fiber composite layer overlaying the thermally conductive hybrid layer. The thermally conductive hybrid layer comprises a polymer matrix with glass or ceramic and a first thermally conductive material disposed therein.

The disclosure should not be construed as limited to the embodiments set forth herein. Rather, these embodiments are provided so that this disclosure will be thorough and complete, and will fully convey the subject matter to those skilled in the art.

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

As discussed hereinabove, metal articles are heavy and may have desirable mechanical properties to withstand demanding environments. For example, gun barrels made of steel or titanium have the strength and stiffness to withstand the pressure created when a bullet is fired and maintain uniform projectile trajectories (i.e., grouping). Conventionally, in an attempt to reduce weight while maintaining these mechanical properties, the amount of metal may be reduced and replaced with a carbon fiber-reinforced thermoset resin. However, carbon fiber-reinforced thermoset resin is a poor heat conductor perpendicular to the fiber direction and, thus, the heat retention in the gun barrel may be increased as compared to an all metal gun barrel, leading to reduced accuracy and wearing down of the gun barrel.

Disclosed herein are multilayer articles, which mitigate the aforementioned problems. Specifically, the multilayer articles disclosed herein comprise a metal layer, a thermally conductive hybrid layer, and a thermally conductive continuous fiber composite layer, which results in a lightweight multilayer article having improved heat transfer. The thermally conductive hybrid layer has a relatively low density and, thus, contributes to the reduced overall weight of the multilayer article. Additionally, the thermally conductive hybrid layer and the thermally conductive continuous fiber composite layer are conductive and help transfer heat away from the metal layer.

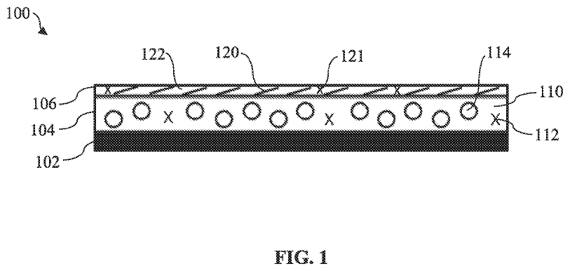

Referring now to FIG. 1, the multilayer articles 100 disclosed herein may generally be described as including a metal layer 102, a thermally conductive hybrid layer 104 overlaying the metal layer 102, and a thermally conductive continuous fiber composite layer 106 overlaying the thermally conductive hybrid layer 104. In embodiments, the thermally conductive hybrid layer 104 may be adjacent to the metal layer 102. In embodiments, the thermally conductive hybrid layer 104 may be adhered to the metal layer 102 using a small amount of the matrix material described further below. In embodiments, the thermally conductive continuous fiber composite layer 106 may be adjacent to the thermally conductive hybrid layer 104.

### Metal Layer

As described hereinabove, a metal layer 102 is included in the multilayer article 100 to provide strength and stiffness to withstand demanding environments (e.g., gun barrel).

In embodiments, the metal layer 102 may comprise a metal or a metal alloy. In embodiments, the metal layer may comprise steel, stainless steel, titanium, brass, red brass, iron, bronze, aluminum, or a combination thereof. In embodiments, the steel may comprise chrome-molybdenum alloy steel, such as grades AISI 4140, AISI 4150, AISI 4340, and AISI 4350. In embodiments, the stainless steel may comprise 17-4 PH or SAE steel grades 410, 416, or 416R.

In embodiments, the metal layer 102 may have a thickness from 1.27 mm (0.050 in.) to 7.62 mm (0.3 in), from 2.54 mm (0.100 in.) to 6.35 mm (0.25 in), or even from 3.18 mm (0.125 in.) to 5.08 mm (0.2 in), or any and all sub-ranges formed from any of these endpoints.

### Thermally Conductive Hybrid Layer

As described hereinabove, a thermally conductive hybrid layer 104 overlays the metal layer 102. The thermally conductive hybrid layer 104 included in the multilayer article 100 has a relatively low density and, thus, contributes to the reduced overall weight of the multilayer article 100. Additionally, the thermally conductive hybrid layer 104 is conductive and helps transfer heat away from the metal layer 102.

In embodiments, the thermally conductive hybrid layer 104 comprises a polymer matrix 110 with glass or ceramic and a first thermally conductive material 112 disposed therein.

In embodiments, the thermally conductive hybrid layer 104 comprises a polymer matrix with ceramic better suited for the end uses of the multilayer articles described herein.

In embodiments, the thermally conductive hybrid layer 104 may comprise hollow beads 114 disposed in the polymer matrix 110. In embodiments, the hollow beads 114 may comprise glass. In embodiments, the hollow beads 114 may comprise ceramic.

Various hollow bead structures are considered suitable. In embodiments, the hollow beads 114 may comprise rounded or spherical beads to ensure equal distribution of stress during use of the multilayer article (e.g., expansion on a gun barrel during firing), thereby preventing or eliminating cracking. In these embodiments, it is contemplated that at least 60 wt %, at least 75 wt %, at least 80 wt %, at least 85 wt %, at least 90 wt %, at least 95 wt %, at least 99 wt %, or 100 wt % of the hollow beads would be rounded or spherical.

From a size standpoint, the hollow beads may have a particle size from 1 μm to 50 μm or even from 10 μm to 40 μm. In embodiments, the hollow beads may have a particle size from 50 μm to 150 μm or even from 75 μm to 125 μm. In embodiments, the hollow beads may have a particle size from 100 μm to 400 μm or even from 150 μm to 300 μm.

Suitable commercial embodiments of the hollow beads are available under the Zeeospheres brand, such as N-800, from Zeeospheres Ceramics, LLC; under the E-Spheres brand, such as SLG, from Envirospheres PTY LTD; and hollow ceramic cenospheres. such as Extendoshpheres from SphereOne.

In embodiments, the first thermally conductive material 112 may comprise carbon fiber (e.g., milled carbon fiber), carbon nanomaterial (e.g., graphene, carbon black, and diamond dust), silver, copper, a ceramic blend (e.g., boron nitride, aluminum beryllium oxide, and aluminum nitride), or a combination thereof.

In embodiments, the polymer matrix 110 of the thermally conductive hybrid layer 104 may comprise thermoplastic polymer, thermoset polymer, or a combination thereof. In embodiments, the thermoplastic polymer may comprise polyamides, polyphenylene sulfides, polyetherimides, polysulfones, polyethersulfones, polyketones, polyaryletherketones (e.g., polyetherketones, polyetheretherketones, polyetherketoneketones), or a combination thereof. In embodiments, the thermoset polymer may comprise Bisphenol A epoxy, Bisphenol F epoxy, novolac epoxy, phenolic resin, bismaleimide, benzoxazine, cyanate resin, or a combination thereof. In embodiments, the thermoset polymer may further comprise curing agents, catalysts, or a combination thereof.

In embodiments, the thermally conductive hybrid layer 104 may have a thickness from 0.127 mm (0.005 in.) to 10.16 mm (0.4 in), from 0.254 mm (0.01 in.) to 7.62 mm (0.3 in), or even from 1.27 mm (0.05 in.) to 5.08 mm (0.2 in), or any and all sub-ranges formed from any of these endpoints.

In embodiments, for example where the thermally conductive continuous fiber composite layer 106 and the thermally conductive hybrid layer 104 are assembled as one piece and then attached to the metal layer 102, the thermally conductive hybrid layer 104 may be adhered to metal layer 102 to form the multilayer articles 100. In embodiments, the thermally conductive hybrid layer 104 may be adhered to metal layer 102 using one or more of the polymer matrix materials as described below. In embodiments, the matrix material used in the thermally conductive hybrid layer 104 may be used to adhere the thermally conductive hybrid layer 104 to the metal layer 102.

In embodiments, the thermally conductive continuous fiber composite layer may include a weight percent of the polymer matrix, based upon the total weight of the thermally conductive continuous fiber composite layer, in the range of 30 wt % to 90 wt %, 40 wt % to 85 wt %, 45 wt % to 80 wt %, 50 wt % to 75 wt %, or any and all sub-ranges formed from any of these endpoints.

In embodiments, the thermally conductive continuous fiber composite layer may include a weight percent of the glass or ceramic, based upon the total weight of the thermally conductive continuous fiber composite layer, in the range of 10 wt % to 65 wt %, 15 wt % to 60 wt %, 20 wt % to 55 wt %, 25 wt % to 50 wt %, or any and all sub-ranges formed from any of these endpoints.

In embodiments, the thermally conductive continuous fiber composite layer may include a weight percent of the first thermally conductive material, based upon the total weight of the thermally conductive continuous fiber composite layer, in the range of 1 wt % to 5 wt %, 1.5 wt % to 4.5 wt %, 2 wt % to 4 wt %, 2.5 wt % to 3.5 wt %, or any and all sub-ranges formed from any of these endpoints.

### Thermally Conductive Continuous Fiber Composite Layer

As described hereinabove, a thermally conductive continuous fiber composite layer 106 overlays the thermally conductive hybrid layer 104. The thermally conductive continuous fiber composite layer 106 is conductive and helps transfer heat away from the metal layer 102.

In embodiments, the thermally conductive continuous fiber composite layer 106 may comprise continuous fibers 120 (i.e., fibers having long aspect ratios) and a second thermally conductive material 121 disposed in epoxy thermoset polymer 122.

In embodiments, the orientation of the continuous fibers 120 may be selected to provide strength and transfer heat away from the metal layer 102, depending on the end use of the multilayer article. For example, in embodiments, the continuous fibers 120 may provide strength (e.g., hoop strength) and transfer heat around the multilayer article 100, not through it. The second thermally conductive material 121 present in the thermally conductive continuous fiber composite cylinder 206 may help direct heat away from the multilayer article 100.

In embodiments, the continuous fibers 120 may comprise carbon, E-glass, ECR-glass, H-glass, R-glass, S-glass, Kevlar (polyaramid), basalt, or a combination thereof.

In embodiments, the second thermally conductive material 121 may comprise carbon fiber (e.g., milled carbon fiber), carbon nanomaterial (e.g., graphene, carbon black, and diamond dust), silver, copper, a ceramic blend (e.g., boron nitride, aluminum beryllium oxide, and aluminum nitride), or a combination thereof.

In embodiments, the epoxy thermoset polymer 122 may comprise Bisphenol A epoxy, Bisphenol F epoxy, novolac epoxy, phenolic resin, bismaleimide, benzoxazine, cyanate resin, curing agents, catalysts, or a combination thereof.

In embodiments, the thermally conductive continuous fiber composite layer 106 may have a thickness from 1.27 mm (0.050 in.) to 6.35 mm (0.250 in), from 1.905 mm (0.075 in.) to 5.08 mm (0.2 in), or even from 2.54 mm (0.1 in.) to 3.81 mm (0.15 in), or any and all sub-ranges formed from any of these endpoints.

### Multilayer Article

As described herein, the multilayer articles 100 disclosed herein comprise a metal layer 102, a thermally conductive hybrid layer 104, and a thermally conductive continuous fiber composite layer 106, which results in a lightweight multilayer article 100 having improved heat transfer. The thermally conductive hybrid layer 104 has a relatively low density and, thus, contributes to the reduced overall weight of the multilayer article 100. For example, including a thermally conductive hybrid layer 104 in a gun barrel may reduce the weight of the gun barrel from 5 wt % to 50 wt % as compared to a conventional gun barrel. Additionally, the thermally conductive hybrid layer 104 and the thermally conductive continuous fiber composite layer 106 are conductive and help transfer heat away from the metal layer 102.

### Gun Barrel

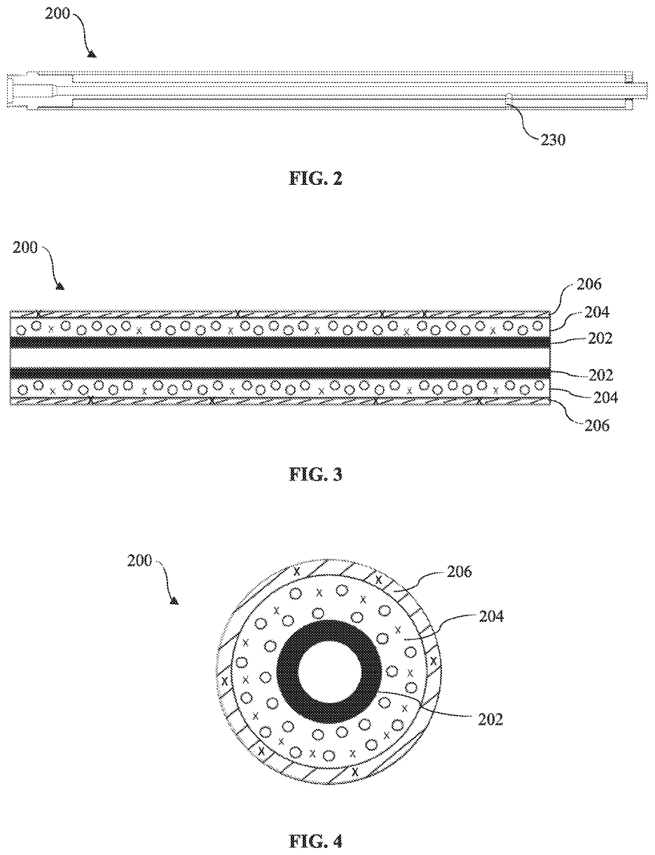

Referring now to FIGS. 2-4, in embodiments, the multilayer articles described herein may be used to form a gun barrel 200. The gun barrel 200 includes a metal cylinder 202 formed from a metal layer as described herein, a thermally conductive hybrid cylinder 204 overlaying the metal cylinder 202 and formed from a thermally conductive hybrid layer as described herein, and a thermally conductive continuous fiber composite cylinder 206 overlaying the thermally conductive hybrid cylinder 204 and formed from a thermally conductive continuous fiber composite layer as described herein.

The thermally conductive hybrid cylinder 204 has a relatively low density and, thus, contributes to the reduced overall weight of the gun barrel 200. Additionally, the thermally conductive hybrid cylinder 204 and the thermally conductive continuous fiber composite cylinder 206 are conductive and help transfer heat away from the metal cylinder 202, leading to improved shooting accuracy and prolonging the wearing down of the gun barrel. Moreover, the differing moduli of the materials used to form the gun barrel 200 dampens the vibrations in the gun barrel when a shot is fired.

In embodiments, the metal cylinder 202 may have an outer diameter of less than or equal to 38.1 mm (1.5 in.), less than or equal to 31.75 mm (1.25 in), or even less than or equal to 25.4 mm (1 in.).

In embodiments, the orientation of the continuous fibers in the thermally conductive continuous fiber composite cylinder 206 may be selected to provide strength and transfer heat away from the metal cylinder 202. For example, in embodiments, the continuous fibers of the thermally conductive continuous fiber composite cylinder 206 may be oriented around the circumference of the cylinder 206 to provide the strength (e.g., hoop strength) necessary to resist expansion when the gun is fired. In such embodiments, the continuous fibers are oriented and to transfer heat around the metal cylinder 202, not through it. The second thermally conductive material present in the thermally conductive continuous fiber cylinder 206 may help direct the heat away from the metal cylinder 202.

In embodiments, the gun barrel 200 may comprise a gas tube port 230. In embodiments, where the gun barrel 200 comprises a gas tube port 230, the gun barrel may be used in a semi-automatic rifle.

In embodiments, to form the gun barrel 200, a thermally conductive hybrid material, including the components of the thermally conductive hybrid layer as described herein, may be applied to a metal cylinder 202 as described herein and cured to form the thermally conductive hybrid cylinder 204 overlaying the metal cylinder 202. In embodiments, the curing of the thermally conductive hybrid material may occur in multiple stages. In embodiments, the thermally conductive hybrid material may be cured at a temperature from 30° C. to 250° C., from 40° C. to 200° C., from 40° C. to 100° C., from 100° C. to 200° C., or any and all sub-ranges formed from any of these endpoints. In embodiments, the thermally conductive hybrid cylinder 204 may be processed (e.g., on a lathe) to produce a smooth, uniform outer surface. In embodiments, the thermally conductive hybrid material may be cured by ramping up the temperature from an initial temperature to a final temperature over a period of 3 to 10 hours, 4 to 8 hours, 5 to 6 hours, or any and all sub-ranges formed from any of these endpoints. In embodiments, the range of temperatures between the initial temperature and the final temperature may be encompassed by 30° C. to 250° C., from 40° C. to 220° C., from 50° C. to 210° C., from 60° C. to 200° C., from 70° C. to 180° C., 80° C. to 150° C., or any and all sub-ranges formed from any of these endpoints. In embodiments, the ramping of temperature from an initial temperature to a final temperature may be continuous or step-wise.

In embodiments, a thermally conductive continuous fiber composite material may be wound on top of the thermally conductive hybrid cylinder 204 to form the thermally conductive continuous fiber composite cylinder 206.

In other embodiments, a pre-fabricated thermally conductive continuous fiber composite cylinder 206 may be pushed over the thermally conductive hybrid material to allow for bonding of the hybrid material to both the metal cylinder 202 and the pre-fabricated composite cylinder 206.

The assembly may be cured at an elevated temperature for a period long enough to fully cure the thermally conductive hybrid material to form the thermally conductive hybrid cylinder 204.

### EXAMPLES

### Example Set A

### Example 1A

50 g of Bisphenol F epoxy (thermoset polymer) and 14.4 g of isophorone diamine (IPDA) (epoxy curing agent) were mixed to form a homogenous solution. 64 g of hollow ceramic spheres (Zeeospheres N-800 from Zeeospheres Ceramics, LLC) were added and continuously mixed into the homogenous solution. 2.6 g of milled carbon fibers were sheared into the homogenous solution including the hollow ceramic spheres to form a thermally conductive hybrid material.

The thermally conductive hybrid material was applied to the outer diameter of a metal cylinder (416 SS). The thermally conductive hybrid material was cured overnight at 49° C. (120° F.) and then post-cured in stages up to 177° C. (350° F.) until fully cured to form the thermally conductive hybrid cylinder. The metal cylinder with the thermally conductive hybrid cylinder attached thereto was placed on a lathe and the outer diameter of the thermally conductive hybrid cylinder was turned down to produce a smooth, uniform surface. The thermally conductive hybrid cylinder had a wall thickness of 3.81 mm (0.150 in.).

The metal cylinder with the attached smoothed thermally conductive hybrid cylinder was placed on a filament winder and 2.54 mm (0.100 in.) of formulated carbon fiber epoxy/amine (100 g of Bisphenol F epoxy+28.8 g of IPDA+5.2 g of milled carbon fiber) was wound on top of the thermally conductive hybrid cylinder to form the thermally conductive continuous carbon fiber composite cylinder.

### Example 2A

Example 2 included the same metal cylinder with the same thermally conductive hybrid material applied to the outer diameter thereof as described in Example 1 (i.e., prior to curing).

A pre-fabricated thermally conductive composite cylinder of carbon fiber composite made with resin containing continuous fiber reinforcement and milled carbon fiber was pushed over the thermally conductive hybrid material while twisting in order to uniformly distribute the mobile matrix of the thermally conductive hybrid material and allow bonding of the hybrid material to both the metal cylinder and the pre-fabricated composite cylinder. The assembly was cured at 49° C. (120° F.) for 4 hours and then post—cured in stages-2 hours of a ramp up to 177° C. (350° F.) and then held for 2 hours at 177° C. (350° F.) until fully cured to form the thermally conductive hybrid cylinder.

Example set B

Example set B involved a set of differing cure profiles which are provided below:

Cure Profile A: 1.5 hrs at 71.1° C. (160° F.), 1.0 hr at 93.3° C. (200° F.), 1.0 hr at 115.6° C. (240° F.), 1.0 hr at 137.8° C. (280° F.) then 1.5 hrs at 176.7° C. (350° F.)

Cure Profile B: 1.0 hr at 71.1° C. (160° F.), 1.0 hr 104.4° C. (220° F.), 1.0 hr at 137.8° C. (280° F.), then 1.5 hr at 148.9° C. (300° F.)

Cure Profile C: 2.0 hr at 71.1° C. (160° F.), 1.0 hr 104.4° C. (220° F.), 1.0 hr at 137.8° C. (280° F.), then 2.5 hr at 148.9° C. (300° F.)

Cure Profile D: 2.0 hrs at 60° C. (140° F.), 1.0 hr at 82.2° C. (180° F.), 1.0 hr at 104.4° C. (220° F.), 1.0 hr at 126.7° C. (260° F.) then 2.5 hrs at 148.9° C. (300° F.)

### Example 1B

100 g of Bisphenol F epoxy (thermoset polymer) and 28.8 g of isophorone diamine (IPDA) (epoxy curing agent) were mixed to form a homogenous solution. 5.2 g of milled carbon fibers were sheared into the resin solution to form a thermally conductive resin. This resin was added to the bath of a filament winder and a 24K carbon fiber tow was used to wind over a 19.05 mm (0.75 in.) mandrel. The winding layup consisted of one layer at 80°, one layer at 60° and two layers at 45° to the mandrel. Once winding was complete a shrink tape was applied to the surface and heated to encapsulate the uncured composite, which was placed in an oven and cured overnight at 49° C. (120° F.). The shrink tape and mandrel were removed and the composite tube was returned to the oven, heated in congruence with Cure Profile A, and allowed to cool naturally within the oven overnight. The tube was then turned on a lathe to an outside diameter of 23.75 mm (0.935 in) and sanded with 400 and 500 grit sandpaper to produce a smooth finish. This tube is herein referred to as “thermally conductive composite tube 1”.

### Example 2B

150 g of Bisphenol F epoxy (thermoset polymer) and 43.2 g of isophorone diamine (IPDA) (epoxy curing agent) were mixed to form a homogenous solution. 7.8 g of milled carbon fibers were sheared into the resin solution to form a thermally conductive resin. This resin was added to the bath of a filament winder and a 24K carbon fiber tow was used to wind over a 19.05 mm (0.75 in.) mandrel. The winding layup consisted of one layer at 80°, one layer at 60°, and four layers at 45° to the mandrel. Once winding was complete a shrink tape was applied to the surface and heated to encapsulate the uncured composite, which was placed in an oven and cured overnight at 49° C. (120° F.). The shrink tape and mandrel were removed and the composite tube was returned to the oven, heated in congruence with Cure Profile B, and allowed to cool naturally within the oven overnight. The tube was then run through a centerless grinder to achieve an outer diameter of 23.75 mm (0.935 in). This tube is herein referred to as “thermally conductive composite tube 2”.

### Example 3B

150 g of Bisphenol F epoxy (thermoset polymer) and 43.2 g of isophorone diamine (IPDA) (epoxy curing agent) were mixed to form a homogenous solution. 7.8 g of milled carbon fibers were sheared into the resin solution to form a thermally conductive resin. This resin was added to the bath of a filament winder and a 24K carbon fiber tow was used to wind over a 19.05 mm (0.75 in.) mandrel. The winding layup consisted of two layers at 80°, one layer at 60°, and 6 layers at 45° to the mandrel. Once winding was complete a shrink tape was applied to the surface and heated to encapsulate the uncured composite, which was placed in an oven and cured overnight at 49° C. (120° F.). The shrink tape and mandrel were removed and the composite tube was returned to the oven, heated in congruence with Cure Profile B, and allowed to cool naturally within the oven overnight. The tube was then turned on a lathe to an outside contour similar to that of a #6 rifle barrel contour and sanded with 400 and 500 grit sandpaper to produce a smooth finish. This tube is herein referred to as “thermally conductive composite tube 3”.

### Example 4B

100 g of Bisphenol F epoxy (thermoset polymer) and 28.8 g of isophorone diamine (IPDA) (epoxy curing agent) were mixed to form a homogenous solution. 5.2 g of milled carbon fibers were sheared into the resin solution to form a thermally conductive resin. This resin was added to the bath of a filament winder and a 24K carbon fiber tow was used to wind over a 19.05 mm (0.75 in.) mandrel. The winding layup consisted of one layer at 80°, one layer at 60° and two layers at 45° to the mandrel. Once winding was complete a shrink tube was applied to the surface and heated to encapsulate the uncured composite, which was placed in an oven and cured overnight at 49° C. (120° F.). The mandrel was removed and the shrink tube was carefully peeled off to preserve the surface finish. The composite tube was returned to the oven, heated in congruence with Cure Profile B, and allowed to cool naturally within the oven overnight. This tube is herein referred to as “thermally conductive composite tube 4”.

### Example 5B

150 g of Bisphenol F epoxy (thermoset polymer) and 43.2 g of isophorone diamine (IPDA) (epoxy curing agent) were mixed to form a homogenous solution. 48.3 g of hollow ceramic spheres (Zeeospheres N-200 from Zeeospheres Ceramics, LLC) were added and continuously mixed into the homogenous solution. 7.8 g of milled carbon fibers were sheared into the resin solution to form a thermally conductive resin. This resin was added to the bath of a filament winder and a 24K carbon fiber tow was used to wind over a 19.05 mm (0.75 in.) mandrel. The winding layup consisted of two layers at 80°, one layer at 60°, and 6 layers at 45° to the mandrel. Once winding was complete a shrink tape was applied to the surface and heated to encapsulate the uncured composite, which was placed in an oven and cured overnight at 49° C. (120° F.). The shrink tape and mandrel were removed and the composite tube was returned to the oven, heated in congruence with Cure Profile C, and allowed to cool naturally within the oven overnight. The tube was then turned on a lathe to an outside contour similar to that of a #6 rifle barrel contour and sanded with 400 and 500 grit sandpaper to produce a smooth finish. This tube is herein referred to as “thermally conductive composite tube 5”.

### Example 6B

A pre-fabricated thermally conductive composite cylinder was fabricated in a continuous process by pulling uni-directional carbon fiber impregnated with an anhydride cured Bisphenol A epoxy resin containing 15% hollow ceramic spheres (Zeeospheres N-800 from Zeeospheres Ceramics, LLC) and 2% milled carbon fibers over a steel mandrel of 17.02 mm (0.670 in) through a system of fiberglass winders winding at 89° to the mandrel. The product was cured in an oven at 177° C. (350° F.) for 1.5 hours and then run through a centerless grinder to a finished OD of 24.51 mm (0.965 in). This tube is herein referred to as “thermally conductive composite tube 6”.

### Example 7B

50 g of Bisphenol F epoxy (thermoset polymer) and 14.4 g of isophorone diamine (IPDA) (epoxy curing agent) were mixed to form a homogenous solution. 64 g of hollow ceramic spheres (Zeeospheres N-800 from Zeeospheres Ceramics, LLC) were added and continuously mixed into the homogenous solution. 2.6 g of milled carbon fibers were sheared into the homogenous solution including the hollow ceramic spheres to form a viscous thermally conductive hybrid resin material.

The thermally conductive hybrid material was applied to the outer diameter of a metal cylinder (416 SS) and encapsulated in a mold. The thermally conductive hybrid material was placed in an oven and allowed to set overnight at 49° C. (120° F.) before being cured in accordance with Cure Profile B to form the thermally conductive hybrid cylinder. The metal cylinder with the thermally conductive hybrid cylinder attached thereto was placed on a lathe and the outer diameter of the thermally conductive hybrid cylinder was turned down to produce a smooth, uniform surface. The thermally conductive hybrid cylinder had a wall thickness of 3.81 mm (0.150 in.).

The metal cylinder with the attached smoothed thermally conductive hybrid cylinder was placed on a filament winder and 2.54 mm (0.100 in.) of T700S 24K carbon fiber and formulated epoxy/amine (100 g of Bisphenol F epoxy+28.8 g of IPDA+5.2 g of milled carbon fiber) was wound on top of the thermally conductive hybrid cylinder in a winding layup of two layers at 80° and two layers at 60° with reference to the cylinder. The wound system was placed in an oven and set overnight at 49° C. (120° F.) then heated in congruence with Cure Profile A to form the thermally conductive continuous carbon fiber composite cylinder. The three-layered article was then placed on a lathe and the surface carbon layer was turned down to an outer diameter of 23.75 mm (0.935 in) resulting thus with a hybrid layer of 3.81 mm (0.150 in) thickness and a composite layer of 1.715 mm (0.0675 in) thickness.

### Example 8B

Example 8B included the same metal cylinder with the bonded thermally conductive hybrid material turned to produce a hybrid cylinder as described in Example 7B.

The cured thermally conductive hybrid layer was turned to a smooth finish with wall thickness of 1.40 mm (0.055 in). Another layer of the viscous thermally conductive hybrid resin was applied to the surface of the cured hybrid layer. Thermally conductive composite tube 6 was pushed over the viscous thermally conductive hybrid resin material while twisting in order to uniformly distribute the mobile uncured resin material and allow bonding of the hybrid material to both the metal cylinder and the pre-fabricated composite cylinder. The assembly was placed in an oven and set overnight at 49° C. (120° F.) then cured at in accordance with Cure Profile C. Once fully cured, the three-layered article constituted a final product with a 2.16 mm (0.085 in) thick thermally conductive hybrid layer and a 3.76 mm (0.148 in) thick thermally conductive composite layer.

### Example 9B

Example 9B includes the same metal cylinder with the same thermally conductive hybrid material applied to the outer diameter thereof as described in Example 7B (i.e., prior to curing).

A layer of the viscous thermally conductive hybrid material was applied to the surface of the metal cylinder. Thermally conductive composite tube 6 was pushed over the viscous thermally conductive hybrid resin material while twisting in order to uniformly distribute the mobile uncured resin material and allow bonding of the hybrid material to both the metal cylinder and the pre-fabricated composite cylinder. The assembly was placed in an oven and set overnight at 49° C. (120° F.) then cured according to Cure Profile C until the hybrid middle layer was fully cured, creating a three-layered thermally conductive article comprised of a thermally conductive hybrid layer 0.38 mm (0.015 in) thick and a thermally conductive composite layer 3.76 mm (0.148 in) thick.

### Example 10B

Example 10B included the same metal cylinder with the same thermally conductive hybrid material applied to the outer diameter thereof as described in Example 7B (i.e., prior to curing).

A layer of the viscous thermally conductive hybrid material was applied to the surface of the metal cylinder. Thermally conductive composite tube 1 was pushed over the viscous thermally conductive hybrid resin material while twisting in order to uniformly distribute the mobile uncured resin material and allow bonding of the hybrid material to both the metal cylinder and the pre-fabricated composite cylinder. The assembly was placed in an oven and set overnight at 49° C. (120° F.) then cured according to Cure Profile C until the hybrid middle layer was fully cured, creating a three-layered thermally conductive article comprised of a thermally conductive hybrid layer 0.38 mm (0.015 in) thick and a thermally conductive composite layer 3.76 mm (0.148 in) thick.

### Example 11B

Example 11B included the same metal cylinder with the same thermally conductive hybrid material as described in Example 7B (i.e., prior to curing).

Thermally conductive composite tube 2 was positioned around the metal cylinder and affixed with clamps. The thermally conductive hybrid material was poured in between the layers to fill the interstitial space. A cap was placed into the end of the metal cylinder and around the conductive composite cylinder in order to center the position of each layer. The assembled and clamped system was cured overnight 49° C. (120° F.) and then cured by way of Cure Profile C until the hybrid middle layer was fully cured, creating a three-layered thermally conductive article with a thermally conductive hybrid layer 3.18 mm (0.125 in) thick and a thermally conductive composite layer 2.35 mm (0.0925 in) thick.

### Example 12B

Example 12B included the same metal cylinder with the same thermally conductive hybrid material as described in Example 7B (i.e., prior to curing).

Thermally conductive composite tube 2 was positioned around the metal cylinder and affixed with clamps. The thermally conductive hybrid material was poured in between the layers to fill the interstitial space. A cap was placed into the end of the metal cylinder and around the conductive composite cylinder in order to center the position of each layer. The assembled and clamped system was cured overnight 49° C. (120° F.) and then cured by way of Cure Profile D until the hybrid middle layer was fully cured, creating a three-layered thermally conductive article with a thermally conductive hybrid layer 3.18 mm (0.125 in) thick and a thermally conductive composite layer 2.35 mm (0.0925 in) thick.

### Example 13B

Example 13B included the same metal cylinder with the same thermally conductive hybrid material as described in Example 7B (i.e., prior to curing).

50 g of Bisphenol F epoxy (thermoset polymer) and 14.4 g of isophorone diamine (IPDA) (epoxy curing agent) were mixed to form a homogenous solution. 96 g of hollow ceramic spheres (Zeeospheres N-800 from Zeeospheres Ceramics, LLC) were added and continuously mixed into the homogenous solution. 3.9 g of milled carbon fibers were sheared into the homogenous solution including the hollow ceramic spheres to form a viscous thermally conductive hybrid resin paste (material with higher viscosity than that produced in Example 7B). This paste was added to the first three inches of the surface of the metal cylinder. Thermally conductive composite tube 2 was pushed over the paste and affixed using a clamp. The same thermally conductive hybrid material from Example 7B was then poured into the remaining interstitial area between the metal and composite cylinders. A cap was placed onto the end of the metal cylinder and around the conductive composite cylinder in order to center the position of each layer. The assembled and clamped system was set overnight 49° C. (120° F.) and then post-cured according to Cure Profile C forming a three-layered thermally conductive article with a thermally conductive hybrid layer 3.18 mm (0.125 in) thick and a thermally conductive composite layer 2.35 mm (0.0925 in) thick.

### Example 14B

Example 14B included the same metal cylinder with the same thermally conductive hybrid material as described in Example 7B (i.e., prior to curing).

The thermally conductive paste from Example 13B was added to the first three inches of the surface of the metal cylinder. Thermally conductive composite tube 3 was pushed over the paste and affixed using a clamp. The same thermally conductive hybrid material from Example 7B was then poured into the remaining interstitial area between the metal and composite cylinders. A cap was placed onto the end of the metal cylinder and around the conductive composite cylinder in order to center the position of each layer. The assembled and clamped system was set overnight 49° C. (120° F.) and then post-cured according to Cure Profile D forming a three-layered thermally conductive article with a thermally conductive hybrid layer 3.18 mm (0.125 in) thick and a thermally conductive composite layer 2.35 mm (0.0925 in) thick.

### Example 15B

Example 15B included the same metal cylinder with the same thermally conductive hybrid material as described in Example 7B (i.e., prior to curing).

The thermally conductive paste from Example 13B was added to the first three inches of the surface of the metal cylinder. Thermally conductive composite tube 4 was pushed over the paste and affixed using a clamp. The same thermally conductive hybrid material from Example 7B was then poured into the remaining interstitial area between the metal and composite cylinders. A cap was placed onto the end of the metal cylinder and around the conductive composite cylinder in order to center the position of each layer. The assembled and clamped system was set overnight 49° C. (120° F.) and then post-cured according to Cure Profile D forming a three-layered thermally conductive article with a thermally conductive hybrid layer 3.18 mm (0.125 in) thick and a thermally conductive composite layer 2.35 mm (0.0925 in) thick.

### Example 16B

Example 16B included the same steps, components, and three-layered thermally conductive article from Example 15B.

The completed three-layered thermally conductive article was placed in a lathe and a two inch length more or less in the middle of the composite section was turned down to remove all of the composite and hybrid material, exposing the metal cylinder. A 2.16 mm (0.085 in) hole was drilled through one side of the metal cylinder in the exposed section. An aluminum gas block was affixed to the metal section and aligned with the hole for gas release control from gases in the metal tube.

### Example Set C

Various examples were tested for thermal performance. Evaluations were conducted with a focus on gun barrels constructed with the thermally conductive three-layered articles. All barrel testing was conducted with the same caliber (6.5 Creedmoor).

### Example 1C

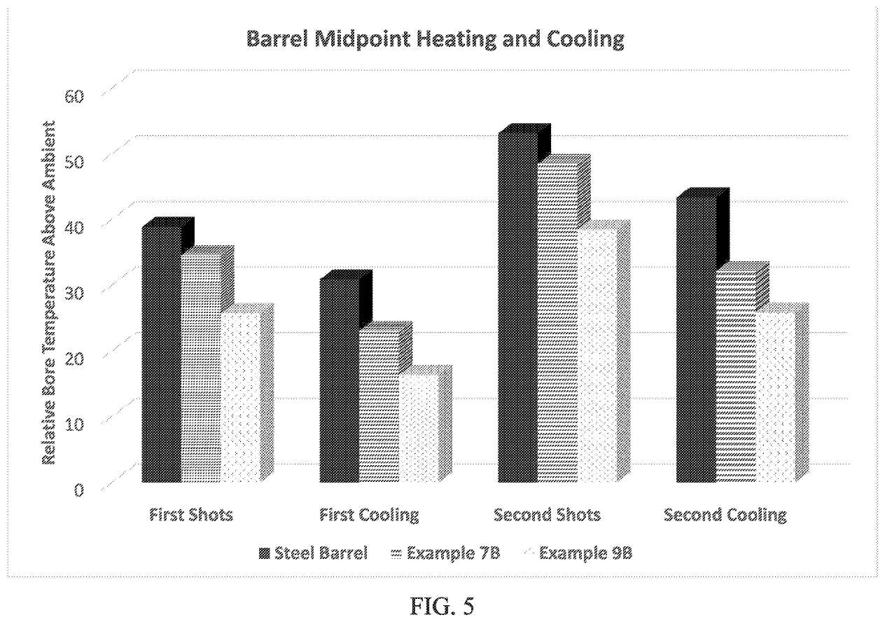

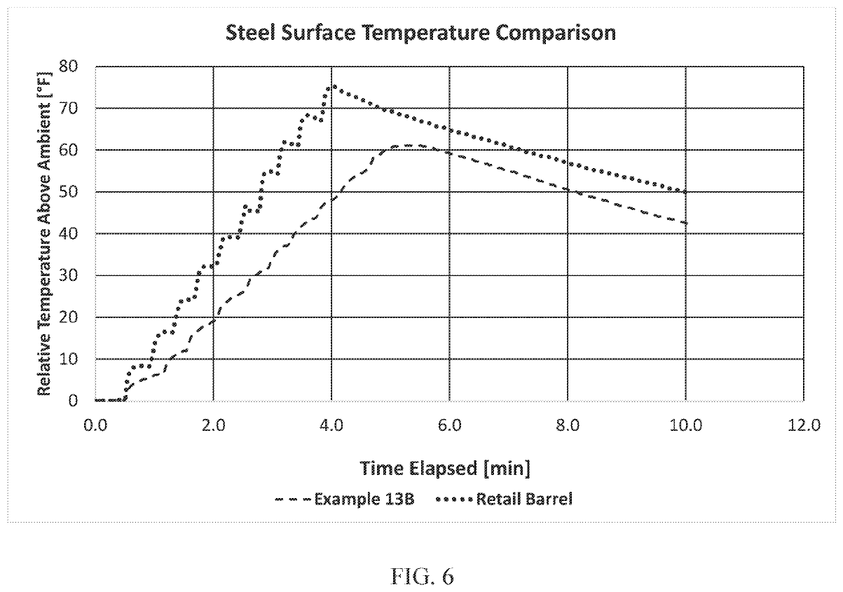

A practical thermal test was performed to compare barrels generated in Examples 7B and 9B to a traditional steel barrel. The steel barrel selected for comparison is a traditional “sporter” barrel typically found in a hunting rifle configuration. Testing evaluated the effects of shooting a set number of rounds in a set time period and how the barrel bores heated and then cooled afterwards. During this testing, 20 rounds were fired through each barrel: initially, 5 shots were fired at a cadence of one shot every ten seconds. The internal bore temperature was immediately measured at the mid-point of the barrel by clearing the chamber, opening the bolt for safety, and inserting a thermocouple attached to a polymer wand to a set depth. Temperature was recorded and the barrel was allowed to cool for 180 seconds at which point the temperature was recorded again at which point the wand was removed, the rifle was reloaded, and the above steps were repeated. Once the second heating and cooling temperatures were recorded, the barrel was allowed to cool for one hour to return to ambient temperature and the above was repeated. The average temperatures after the first and second shooting and cooling periods are displayed in FIG. 5.

### Example 2C

Another test was conducted comparing a barrel generated in Example 13 and a carbon-reinforced barrel currently available by retail. The carbon-reinforced barrel was selected as it is recognized by consumers in the industry as one of the best performing with regards to thermal dissipation. In this test thermocouples were affixed to each barrel at the surface of the steel (i.e. beneath the carbon fiber layer of the retail barrel and between the carbon and hybrid layers of the barrel from Example 13B) two inches down-barrel from the chamber. Both barrels were shot 10 times in a relatively brief span and the thermocouple readings were recorded to provide a real-time thermal evaluation of the heat flow at the surface of the steel component of the barrel. FIG. 6 displays the results of this test.

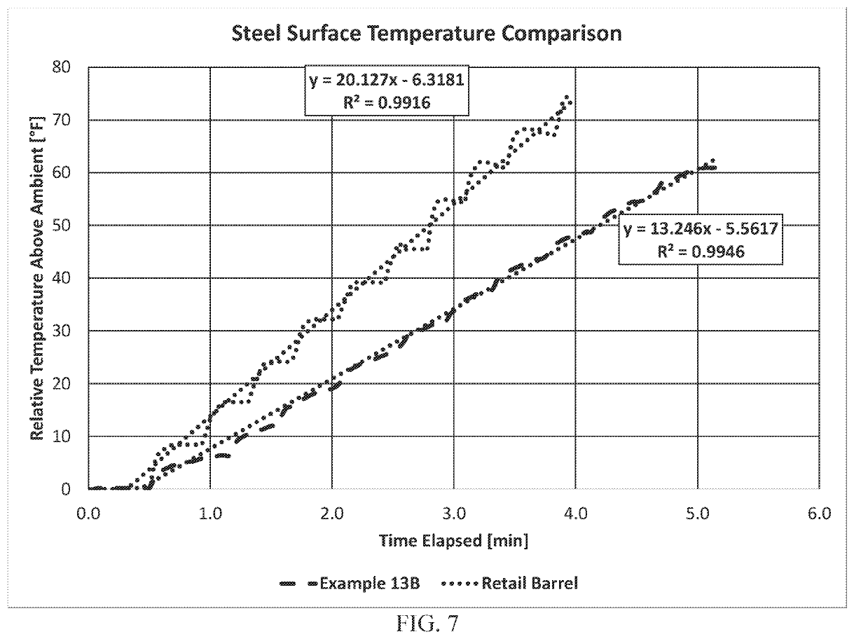

When evaluated visually, the data from the shot testing shows the barrel from Example 13B does not heat as quickly nor does it reach the same maximum temperature as the retail barrel to which it is compared after ten shots. On both curves, each of the individual shots can be observed by a thermal impulse which quickly affects the system and is then observed to settle as heat is distributed throughout the barrel. These impulses are much clearer on the retail barrel and are softer in the barrel from Example 13B which suggests the increase in temperature as more rounds are fired is a more consistent rate of heating without major impulses or “shocks” to the surrounding systems in the multi-layered hybrid system. Also, visually, a linear interpretation of the slope of temperature increase between the barrels suggests the rate of increase in the retail barrel is higher than that of the Example 13B barrel. However, since the time elapsed between sets of 10 shots is not exactly equal between barrels, a mathematical evaluation is required to confirm this difference. FIG. 7B shows the same data from FIG. 5 and ending the data sets at the peak temperature achieved. A linear line of fit and its associated equation are overlaid on each curve.

The rate of increase as determined by slope on the graph is 20.1° F./min and 13.2° F./min for the retail barrel and Example 13B barrel, respectively. When algebraically solved to calculate temperature increase per shot taken, the results are 8.05° F./shot and 6.89° F./shot for the retail barrel and Example 13B barrel, respectively. This direct comparison suggests the retail barrel heats up during shooting at a rate 17% greater than that of the barrel produced with the multi-layered hybrid system.

### Example 3C

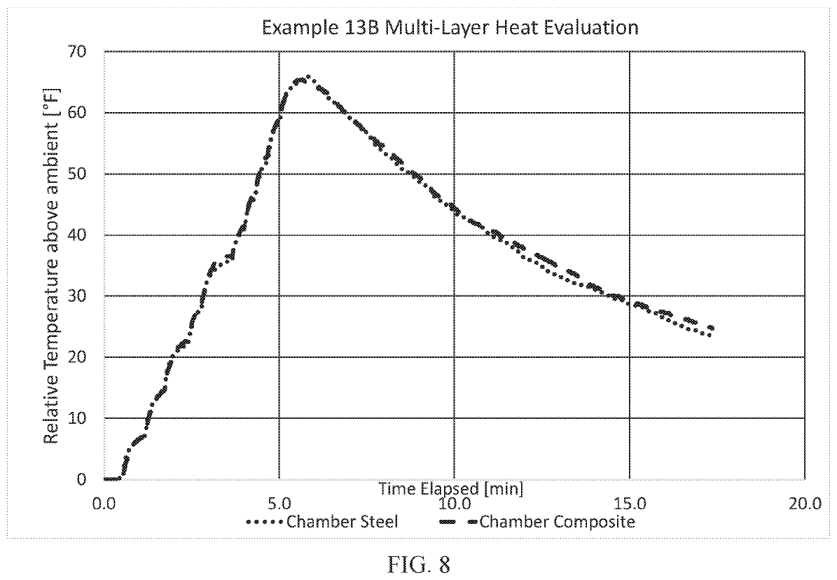

In an effort to better understand the results from Example 2C and to determine the effect of the thermally conductive hybrid layer on heat dissipation, further evaluations were completed on the barrel produced in Example 13B to map radial heat flow through the multi-layered article. Another thermocouple was embedded beneath the composite layer opposite the previously embedded thermocouple. This resulted in one thermocouple reading the interface between the steel and hybrid layers and the other between the hybrid and composite layers at the same position along the length of the barrel. Ten more rounds were fired while collecting the readings from the thermocouples; FIG. 8 displays this data.

As described in Example 13B, the thermally conductive hybrid material in the barrel evaluated was 3.18 mm (0.125 in) thick around the circumference of the article. The results displayed in FIG. 8 show a nearly perfect time and temperature correlation between the two surfaces of the hybrid layer as each shot is fired and as the cooling occurs after the 10 rounds had been expended. This outcome suggests the thermal energy generated while firing the rifle is transferred immediately or nearly immediately through the interstitial layer from the steel to the inner composite surface layer.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

What is claimed is:

1. A multilayer article comprising:
a metal layer;
a thermally conductive hybrid layer overlaying the metal layer, the thermally conductive hybrid layer comprising a polymer matrix with glass or ceramic and a first thermally conductive material disposed therein; and
a thermally conductive continuous fiber composite layer overlaying the thermally conductive hybrid layer.

2. The multilayer article of claim 1, wherein the metal layer comprises steel, stainless steel, titanium, brass, red brass, iron, bronze, aluminum, or a combination thereof.

3. The multilayer article of claim 1, wherein the thermally conductive hybrid layer comprises hollow beads disposed in the polymer matrix.

4. The multilayer article of claim 3, wherein the hollow beads comprise glass.

5. The multilayer article of claim 3, wherein the hollow beads comprise ceramic.

6. The multilayer article of claim 3, wherein the hollow beads have a spherical shape.

7. The multilayer article of claim 3, wherein the first thermally conductive material comprises carbon fiber, carbon nanomaterial, silver, copper, a ceramic blend, or a combination thereof.

8. The multilayer article of claim 3, wherein the polymer matrix of the thermally conductive hybrid layer comprises thermoplastic polymer, thermoset polymer, or a combination thereof.

9. The multilayer article of claim 8, wherein the thermoplastic polymer comprises polyamides, polyphenylene sulfides, polyetherimides, polysulfones, polyethersulfones, polyketones, polyaryletherketones, or a combination thereof.

10. The multilayer article of claim 8, wherein the thermoset polymer comprises Bisphenol A epoxy, Bisphenol F epoxy, novolac epoxy, phenolic resin, bismaleimide, benzoxazine, cyanate resin, or a combination thereof.

11. The multilayer article of claim 1, wherein the thermally conductive continuous fiber composite layer comprises continuous fibers and a second thermally conductive material disposed in epoxy thermoset polymer.

12. The multilayer article of claim 11, wherein the continuous fibers comprise carbon fibers.

13. The multilayer article of claim 11, wherein the second thermally conductive material comprises carbon fiber, carbon nanomaterial, silver, copper, a ceramic blend, or a combination thereof.

14. A gun barrel comprising the multilayer article of claim 1.

15. The gun barrel of claim 14, wherein the gun barrel comprises a gas tube port.

16. The multilayer article of claim 5, wherein the hollow beads have a spherical shape.

17. The multilayer article of claim 5, wherein the first thermally conductive material comprises carbon fiber, carbon nanomaterial, silver, copper, a ceramic blend, or a combination thereof.

18. The multilayer article of claim 5, wherein the polymer matrix of the thermally conductive hybrid layer comprises a thermoplastic polymer.

19. The multilayer article of claim 5, wherein the polymer matrix of the thermally conductive hybrid layer comprises a thermoset polymer.

20. The multilayer article of claim 5, wherein the first thermally conductive material comprises carbon fiber, carbon nanomaterial, silver, copper, a ceramic blend, or a combination thereof.
